(19) United States
(12) Patent Application Publication
(10) Pub. No.: US 2026/0119288 A1
(43) Pub. Date: Apr. 30, 2026

(54) SYSTEM AND METHOD FOR ENHANCED OBSERVABILITY WITHIN APPLICATION CONTAINERS ON A CONTAINER ORCHESTRATION PLATFORM

(71) Applicant: BANK OF AMERICA CORPORATION, Charlotte, NC (US)

(72) Inventors: Amer Ali, Jersey City, NJ (US); Brian Christman, Stephenville, TX (US); Mohammad Saleem Gaziani, Plano, TX (US); Aaron Gee, Palm Coast, FL (US); Aisha Jenkins, Atlanta, GA (US); John Lozes, Wilmington, DE (US); Tonya Kyra Miller, Charlotte, NC (US); Manonmani Palanichamy, Fort Mill, SC (US); Naresh Kumar Petapalle, Welling (GB); Shahzad Riasat, Irving, TX (US); Jyothishwar Reddy Sama, Fort Mill, SC (US); Aravind Singtalur, McKinney, TX (US); Asha Thekkumpurath, Frisco, TX (US); Andrea M. Weisberger, Jacksonville, FL (US)

(73) Assignee: BANK OF AMERICA CORPORATION, Charlotte, NC (US)

(21) Appl. No.: 18/930,443

(22) Filed: Oct. 29, 2024

(51) Int. Cl. G06F 9/54; H04L 67/02

(52) U.S. Cl. CPC G06F 9/547; H04L 67/02

(57) ABSTRACT

Systems, computer program products, and methods are described herein for enhanced observability within application containers on a container orchestration platform. The present disclosure is configured to: receive an application container within a container orchestration platform, wherein the application container comprises an internal state; embed a container application programming interface (API) within the application container, wherein the container API is linked to an external observability service; transmit a hyper text transfer protocol (HTTP) call from the external observability service to the container API within the application container; observe the internal state of the application container via the container API; and transmit the internal state of the of the application container from the container API to the external observability service.

### TECHNOLOGICAL FIELD

Example embodiments of the present disclosure relate to enhanced observability within application containers on a container orchestration platform.

### BACKGROUND

While container orchestration platforms may provide a plurality of tools for manipulation of application container, observing an application container within the container orchestration platform presents multiple issues.

Applicant has identified a number of deficiencies and problems associated with enhanced observability within application containers on a container orchestration platform. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for enhanced observability within application containers on a container orchestration platform. In one aspect, a system for enhanced observability within application containers on a container orchestration platform is presented. The system including a processing device, at least one non-transitory storage device, and at least one processing device coupled to the at least one non-transitory storage device wherein the at least one processing device may be configured to: receive an application container within a container orchestration platform, wherein the application container comprises an internal state; embed a container application programming interface (API) within the application container, wherein the container API is linked to an external observability service; transmit a hyper text transfer protocol (HTTP) call from the external observability service to the container API within the application container; observe the internal state of the application container via the container API; and transmit the internal state of the of the application container from the container API to the external observability service.

In some embodiments, the at least one processing device is further configured to transmit the internal state of the application container to a machine learning model.

In some embodiments, observation of the internal state of the application container occurs on a predetermined periodic basis.

In some embodiments, observation of the internal state of the application container is triggered from the external observability service receiving a predetermined signal from the container API within the application container.

In some embodiments, reception of the predetermined signal alters when the internal state of the application container is observed.

In some embodiments, a set of authentication credentials are received by the external observability service to trigger observation of the internal state of the application container.

In some embodiments, the container API is changed based on the internal state of the application container.

In another aspect, a computer program product for enhanced observability within application containers on a container orchestration platform is presented. The computer program product comprising at least one non-transitory computer-readable medium having computer-readable program code portions embodied therein, the computer-readable program code portions which when executed by a processing device are configured to cause the processor to perform the following operations: receive an application container within a container orchestration platform, wherein the application container comprises an internal state; embed a container application programming interface (API) within the application container, wherein the container API is linked to an external observability service; transmit a hyper text transfer protocol (HTTP) call from the external observability service to the container API within the application container; observe the internal state of the application container via the container API; and transmit the internal state of the of the application container from the container API to the external observability service.

In some embodiments, the computer program product is further configured to transmit the internal state of the application container to a machine learning model.

In some embodiments, observation of the internal state of the application container occurs on a predetermined periodic basis.

In some embodiments, observation of the internal state of the application container is triggered from the external observability service receiving a predetermined signal from the container API within the application container.

In some embodiments, reception of the predetermined signal alters when the internal state of the application container is observed.

In some embodiments, a set of authentication credentials are received by the external observability service to trigger observation of the internal state of the application container.

In some embodiments, the container API is changed based on the internal state of the application container.

In another aspect, a computer-implemented method for enhanced observability within application containers on a container orchestration platform is presented. The computer-implemented method may include: receiving an application container within a container orchestration platform, wherein the application container comprises an internal state; embedding a container application programming interface (API) within the application container, wherein the container API is linked to an external observability service; transmitting a hyper text transfer protocol (HTTP) call from the external observability service to the container API within the application container; observing the internal state of the application container via the container API; and transmitting the internal state of the of the application container from the container API to the external observability service

In some embodiments, the computer-implemented method further includes transmitting the internal state of the application container to a machine learning model.

In some embodiments, observation of the internal state of the application container occurs on a predetermined periodic basis.

In some embodiments, observation of the internal state of the application container is triggered from the external observability service receiving a predetermined signal from the container API within the application container.

In some embodiments, reception of the predetermined signal alters when the internal state of the application container is observed.

In some embodiments, a set of authentication credentials are received by the container.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for enhanced observability within application containers on a container orchestration platform, in accordance with an embodiment of the disclosure;

FIG. 2 illustrates an exemplary machine learning (ML) subsystem architecture, in accordance with an embodiment of the disclosure; and

FIG. 3 illustrates a process flow for enhanced observability within application containers on a container orchestration platform, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Container orchestration platforms (e.g., similar to the OpenShift platform) may manage, scale, and orchestrate application containers (e.g., Docker containers) while offering rigid controls and features for observability of application containers. While an application container may be a portable and isolated environment to package an application, the internal state (e.g., the contents within the application container) may present issues associated with monitoring and observing the application container. The internal state of an application container may comprise application code, runtime environment, system libraries with dependencies, configuration files, and temporary file systems that may be difficult to observe in real time.

Observance of the internal state of the application container may be challenged, obstructed, and/or prevented due to numerous factors. An application container by design may be isolated from a host system and other containers, which may limit access to the internal state of the application container. Application containers may also have an ephemeral nature, as containers and the internal state may be subjected to constant changes, updates, starts, stops, and/or redeployments which may increase a demand for resources (e.g., time and computing power) to track the internal state in real time. The lack of observability may cause outdated and inefficient diagnostics regarding an application container, customization constraints, and potential security and compliance anomalies.

Embedding a container application programming interface (container API) within the application container may provide real time information regarding the internal state of the application container on demand. The embedded container API may respond to internal and external queries and activities associated with an application container and provide a bidirectional data flow to the internal state of the application container. The embedded container API may further provide flexible integration within an application container and be linked to further tools for analysis and observability of the application container (e.g., machine learning models that may be used to study, measure, and predict management tools associated with the application container).

Accordingly, the present disclosure describes observing application containers (e.g., Docker containers that may package an application so it can run across various environments) within a container orchestration platform (e.g., Openshift platform). Application containers within container orchestration platforms may have experienced reduced observability, leading to limited real-time monitoring, inefficient diagnostics, potential security anomalies, and customization constraints. Introduction of a container embedded application programing interface (API) service, external hyper text transfer protocol (HTTP) calls to the container's endpoint, and the introduction of machine learning models will provide “snapshots” of the application containers and the contents within.

What is more, the present disclosure provides a technical solution to a technical problem. As described herein, the technical problem includes observing application containers on a container orchestration platform. The technical solution presented herein allows for enhanced observability within application containers on a container orchestration platform. In particular, enhanced observability within application containers on a container platform is an improvement over existing solutions to the application container monitoring, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

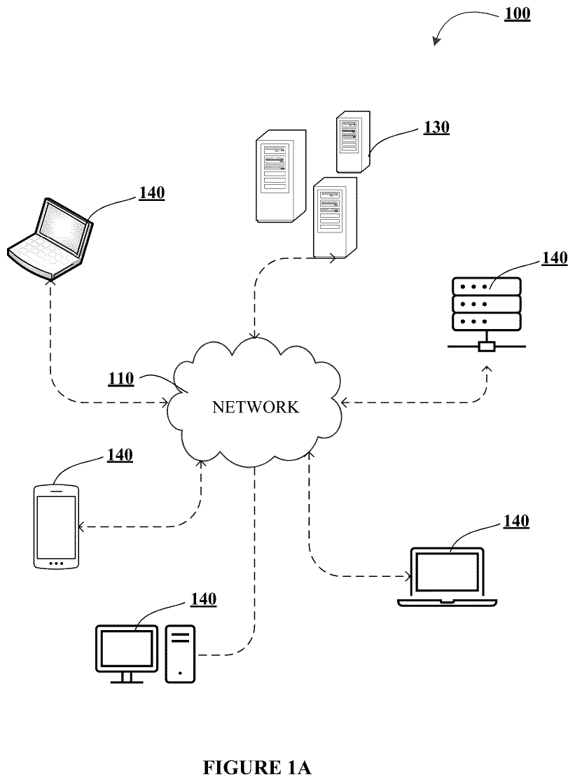

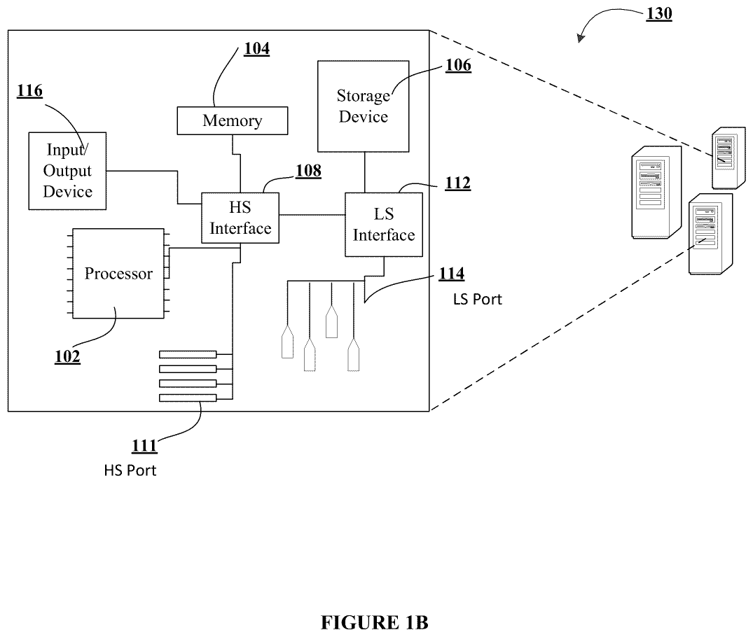

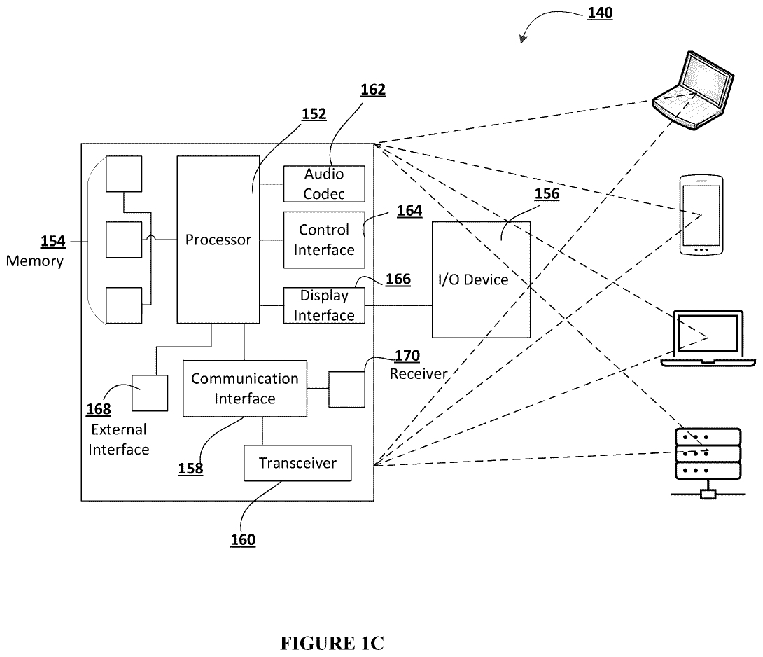

FIGS. 1A-1C illustrate technical components of an exemplary distributed computing environment for enhanced observability within application containers on a container orchestration platform 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

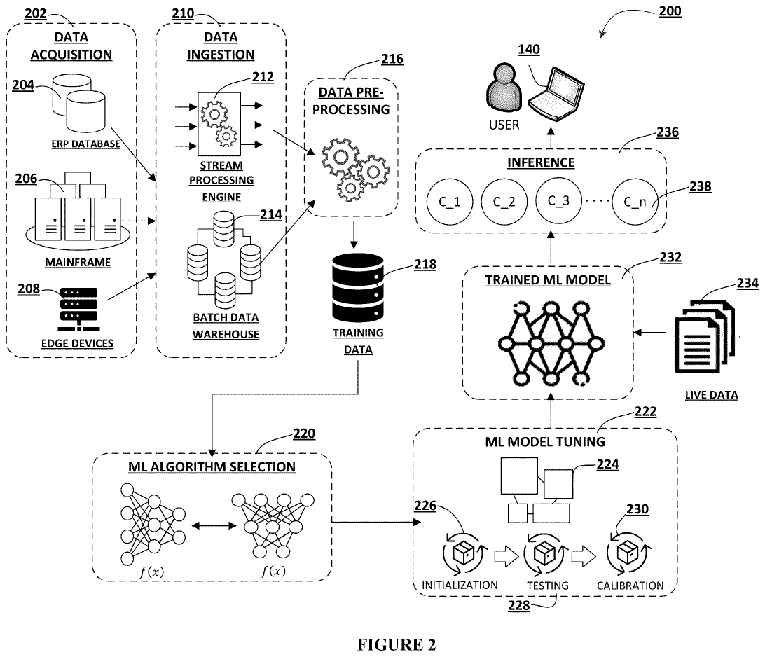

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

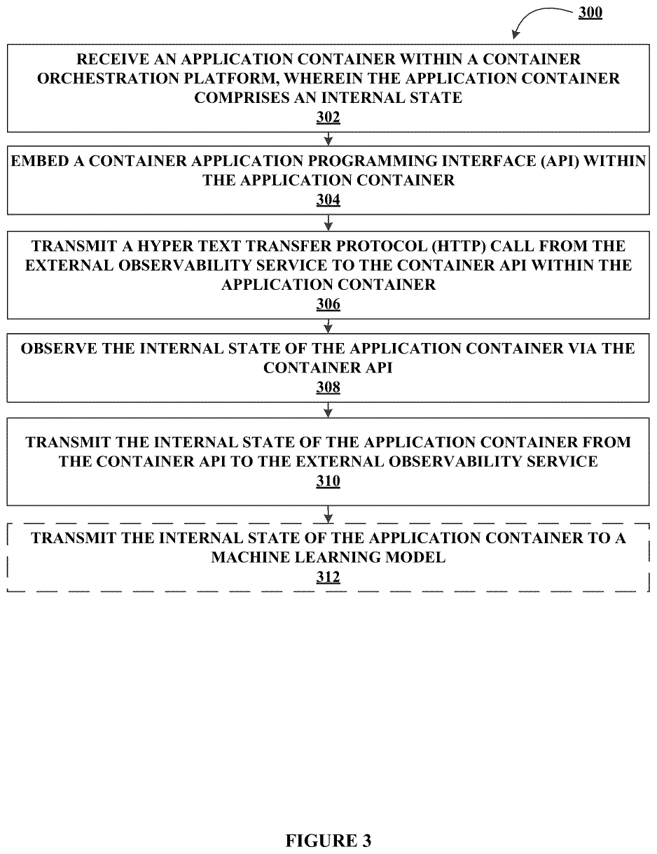

FIG. 3 illustrates a process flow for systems and methods for enhanced observability within application containers on a container orchestration platform. In some embodiments, a system (e.g., similar to one or more of the systems described herein with respect to FIGS. 1A-1C) may perform one or more of the steps of process flow 300. In some embodiments, a generative artificial intelligence engine (e.g., the exemplary machine learning subsystem architecture shown in FIG. 2) may perform some or all the steps described in process flow 300.

As shown in Block 302, the process flow 300 may include the step of receiving an application container within a container orchestration platform. The application container within the container orchestration platform may refer to packaging associated with applications and the application's accompanying dependencies in an isolated environment. An application container may further be referred to as a containerized application, software container, Linux containers, containerized workloads, open container initiative (OCI) compliant containers, or Docker containers. The application container may package and run applications in isolated environments. For instance, the application container may refer to a “docker” or containerization technology. The container orchestration platform may refer to a platform, software, environment, and/or management system that may deploy, manage, interact, scale, and/or manipulate applications and application containers (e.g., OpenShift platform). The container orchestration platform may create an application container from a received application and/or manage an existing application container.

The application container may comprise an internal state. The internal state of the application container may refer to internal contents of the application container, status of the application within the application container, application code, a runtime environment, system libraries and dependencies, configuration files, data/information associated with the application container, and/or temporary file systems. The internal state of the application container may benefit from enhanced observability as application containers may be designed to isolate the host system and other container, which may reduce access to the internal state and file system. Further, the internal state of the application container may be changing or evolving on an inconsistent basis (e.g., start, stop, and/or redeployment may occur at irregular intervals) and utilizing resources to observe the application container may overextend associated systems. Observing the application container via a container application programming interface (API) may enhance observability of the application container, as described in greater detail below.

As shown in Block 304, the process flow 300 may include the step of embedding a container API within the application container. The container API may be linked to an external observability service, the external observability service may be in turn within the container orchestration platform. The container API may be queried for observations, insights, statistics, and/or information regarding the internal state of the application container, as described in greater detail below. Embedding the container API within the application container may comprise packaging the container API, components of the container API, and the container API server. The container API may be a representational state transfer (REST) architecture (e.g. RESTful services) that may provide real time information regarding the internal state of the application container. The container API embedded within the application container may be queried for real time state information (e.g., the internal state of the application container) on command, if prompted, or the internal state of the application container crossing a predetermined threshold as described in greater detail below. The container API may comprise a bidirectional data flow, which may enable the container API to proactively send information/transmit data regarding the internal state of the application container.

As shown in Block 306, the process flow 300 may include the step of transmitting a hyper text transfer protocol (HTTP) call from the external observability service to the container API within the application container. Transmission of the HTTP call may prompt, signal, and/or initiate observing the application container and the internal state within the application container by the container API. The HTTP call from the external observability service may comprise a code and/or signal which may be interpreted by the container AIP to begin retrieval of relevant internal state data of the application container. Transmission of the HTTP call may be conducted on demand (e.g., the HTTP call may be transmitted by a user or by the reception of authentication credentials associated with a user as described in greater detail below) or may be transmitted on a predetermined periodic basis (e.g., the HTTP call may be transmitted once every two hours for updates on the internal state of the application container, as described in greater detail below).

As shown in Block 308, the process flow 300 may include the step of observing the internal state of the application container via the container API. Observing the internal state of the application container may comprise resource usage metrics (e.g., central processing unit (CPU) usage, memory usage, network traffic), container status data, container health data (e.g., running state data, uptime of the application container, health status), log data (e.g., application logs, container logs, events including but not limited to when the application container is started, stopped, restarted, and/or removed), configuration data (e.g., environmental data, volume and storage data, network configurations), metadata and identifiers (e.g., application container identification and names, labels), processing and performance data (e.g., running processes data, thread count), and network connection data. In other words, observing the internal state of the application container by the container API may gather, collect, analyze, process, and/or present data and associated information associated with the application container and the internal state of the application container. Observed data from the internal state of the application container may, in some embodiments, be stored within a database. In another embodiment, observed data from the internal state may be displayed alongside identifiable information regarding the application container.

In some embodiments, observation of the internal state of the application container occurs on a predetermined periodic basis. For instance, the HTTP call transmitted by the external observability service to the container API may occur on a “scheduled” or predetermined frequency (e.g., observing the internal state of the application container may occur once every minute, once every hour, or once every day). In some embodiments, the predetermined periodic basis in which observing the internal state of the application container may occur may be based on events within the application container (e.g., every time the CPU usage passes beyond a predetermined point). Observing the internal state may be a combination of occurring after a predetermined threshold has been passed and then occurring on a predetermined frequency. For instance, the CPU usage passes a predetermined threshold at which point the HTTP call may be transmitted every 30 minutes as opposed to a previous frequency of every hour.

As shown in Block 310, the process flow 300 may include the step of transmitting the internal state of the application container from the container API to the external observability service. Transmission of the internal state of the application container may comprise relaying, providing, and/or sending data, information, statistics, and/or metadata regarding the internal state of the application container. In some embodiments, observation of the internal state of the application container is triggered from the external observability service receiving a predetermined signal from the container API within the application container. The predetermined signal may occur upon the application container passing a predetermined threshold. For instance, the bidirectional data flow accessed through the container API and the external observability service may indicate the health of the application container may be below the predetermined threshold/baseline levels. This may be a predetermined signal which triggers observation of the internal state of the application container (i.e., the HTTP call may be triggered to obtain a “snapshot” of the overall health of the application container). The predetermined signal may be configured to occur after reaching a predetermined threshold and/or an alert regarding the application container. In some embodiments, reception of the predetermined signal alters when the internal state of the application container is observed. For instance, upon receiving the predetermined signal, automatic controls regarding the application container may be activated (e.g., if the CPU usage for the application container is too high, it may automatically be reduced) after observance of the application container.

In some embodiments, a set of authentication credentials are received by the container. The external observability service may, in some embodiments, be protected by the set of authentication credentials to observe the internal state of the application. In other words, the internal state of the application containers may be available after the set of authentication credentials are provided. The set of authentication credentials may be any information that can be used to identify a user, as previously described. The set of authentication credentials may be provided by a user or entity to trigger observance of the application container and the internal state of the application container.

In some embodiments, as shown in Block 312, the process flow 300 may include the step of transmitting the internal state of the application container to a machine learning model (MLM). The MLM may be an exemplary machine learning subsystem architecture, as described in FIG. 2. Data associated with the internal state of the application container (i.e., data observed from the container API) may be transmitted to the MLM which in turn may process and analyze the provided data. The MLM may use the data to recalibrate the frequency at which the application container may be observed, what data is collected from the application container, and/or provide recommendations on management of the application container through the use of a large language model (LLM). The MLM may be operably connected to the application container to make adjustments as determined by the received data.

In some embodiments, the container API is changed based on the internal state of the application container. The container API may be designed, constructed, and/or programmed to change based on the internal state of the container API. For instance, the internal state of the container API may be adjusted if the CPU usage passes a predetermined threshold as well as providing log data of the application container. The internal state of the application container may also be adjusted by the machine learning model, as previously described.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for enhanced observability within application containers on a container orchestration platform, the system comprising:
a processing device;
at least one non-transitory storage device; and
at least one processing device coupled to the at least one non-transitory storage device, wherein the at least one processing device is configured to:
receive an application container within a container orchestration platform,
wherein the application container comprises an internal state;
embed a container application programming interface (API) within the application container,
wherein the container API is linked to an external observability service;
transmit a hyper text transfer protocol (HTTP) call from the external observability service to the container API within the application container;
observe the internal state of the application container via the container API; and
transmit the internal state of the application container from the container API to the external observability service.

2. The system of claim 1, wherein the at least one processing device is further configured to transmit the internal state of the application container to a machine learning model.

3. The system of claim 1, wherein observation of the internal state of the application container occurs on a predetermined periodic basis.

4. The system of claim 1, wherein observation of the internal state of the application container is triggered from the external observability service receiving a predetermined signal from the container API within the application container.

5. The system of claim 4, wherein reception of the predetermined signal alters when the internal state of the application container is observed.

6. The system of claim 1, wherein a set of authentication credentials are received by the container.

7. The system of claim 1, wherein the container API is changed based on the internal state of the application container.

8. A computer program product for enhanced observability within application containers on a container orchestration platform, the computer program product comprising at least one non-transitory computer-readable medium having computer-readable program code portions embodied therein, the computer-readable program code portions which when executed by a processing device are configured to cause a processor to perform the following operations:
receive an application container within a container orchestration platform,
wherein the application container comprises an internal state;
embed a container application programming interface (API) within the application container,
wherein the container API is linked to an external observability service;
transmit a hyper text transfer protocol (HTTP) call from the external observability service to the container API within the application container;
observe the internal state of the application container via the container API; and
transmit the internal state of the application container from the container API to the external observability service.

9. The computer program product of claim 8, wherein the processing device is further configured to cause the processor to: transmit the internal state of the application container to a machine learning model.

10. The computer program product of claim 8, wherein observation of the internal state of the application container occurs on a predetermined periodic basis.

11. The computer program product of claim 8, wherein observation of the internal state of the application container is triggered from the external observability service receiving a predetermined signal from the container API within the application container.

12. The computer program product of claim 11, wherein reception of the predetermined signal alters when the internal state of the application container is observed.

13. The computer program product of claim 8, wherein a set of authentication credentials are received by the external observability service to trigger observation of the internal state of the application container.

14. The computer program product of claim 8, wherein the container API is changed based on the internal state of the application container.

15. A computer-implemented method for enhanced observability within application containers on a container orchestration platform, the computer-implemented method comprising:
receiving an application container within a container orchestration platform,
wherein the application container comprises an internal state;
embedding a container application programming interface (API) within the application container,
wherein the container API is linked to an external observability service;
transmitting a hyper text transfer protocol (HTTP) call from the external observability service to the container API within the application container;
observing the internal state of the application container via the container API; and
transmitting the internal state of the application container from the container API to the external observability service.

16. The computer-implemented method of claim 15, wherein the method further comprises transmitting the internal state of the application container to a machine learning model.

17. The computer-implemented method of claim 15, wherein observation of the internal state of the application container occurs on a predetermined periodic basis.

18. The computer-implemented method of claim 15, wherein observation of the internal state of the application container is triggered from the external observability service receiving a predetermined signal from the container API within the application container.

19. The computer-implemented method of claim 18, wherein reception of the predetermined signal alters when the internal state of the application container is observed.

20. The computer-implemented method of claim 15, wherein a set of authentication credentials are received by the external observability service to trigger observation of the internal state of the application container.
